(19) United States
(12) Patent Application Publication
(10) Pub. No.: US 2006/0288423 A1
(43) Pub. Date: Dec. 21, 2006

(54) Method, system and network elements for establishing media protection over networks

(75) Inventors: Franck Le, Pittsburgh, PA (US); Tat Chan, San Diego, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/236,794

(22) Filed: Sep. 28, 2005

Related U.S. Application Data
(60) Provisional application No. 60/691,281, filed on Jun. 17, 2005.

(51) Int. Cl. H04L 9/32

(52) U.S. Cl. 726/26

(57) ABSTRACT

The invention provides media protection of media flows between a network element such as an end point, for instance a mobile user terminal, and another network element over an access network. When media protection is requested, the network element and an intermediate network element such as media proxy establish a connection providing media protection over the access network. An application layer gateway, ALG, may assist in establishing the connection providing media protection by pushing a security association, SA, to the intermediate network element, so as to enable media protection between the network element and the intermediate network element.

This application claims benefit under 35 U.S.C. 119 (e) of provisional Application No. 60/691,281, filed on Jun. 17, 2005, the contents of which is incorporated by reference.

The invention is related to method, system and network elements for establishing media protection over one or more networks, in particular but not exclusively an access network, for services such as IMS Services (IMS, Internet Multimedia Subsystem).

FIG. 1 shows a basic access structure in which an IMS is accessible via a public IPv4 (Internet Protocol version 4) network using a Public WLAN, Wireless Local Area Network, a Home or a corporate network, a private IPv4 network using e.g. UMTS/GPRS, OWLAN (operator WLAN) or a corporate network, or an IPv6 (Internet Protocol version 6) using e.g. UMTS/GPRS or OWLAN.

A user in a Public WLAN, at Home or in a corporate network is usually able to connect to the IMS using e.g. the public IPv4 network. When connecting to the IMS through such alternative accesses, e.g. Public WLAN, the access link may not be protected. This is contrary to an IMS access via 3GPP networks such as an IPv6 network using e.g. UMTS/GPRS or OWLAN, where the access link is protected which may include encryption or integrity-protection or both encryption and integrity-protection. Unprotected access may cause the danger of potential eavesdropping, spoofing and other attacks. Hence, a user may prefer to protect the media stream over the access network.

End-to-end security with the other end point may be one option, see FIG. 4. However if the other end point belongs to a different operator, there are problems to set up the Security Association, SA, since inter-operator cross certification is currently not supported. Besides, the other end point may not support the media protection protocol and/or key agreement protocol. For instance, the remote end point may be a traditional telephone in the public switched telephone network.

End-to-end media protection can be established between the correspondent nodes. 3GPP IMS reuses many of the IETF communication protocols. In particular, SIP, Session Initiation Protocol, is used as the signaling protocol. Multimedia communication sessions can be established using SIP. The resulting media streams are transported using RTP, RealTime Transport Protocol, protocol. To protect the RTP media traffic, SRTP, Secure RTP, can be used. To set up keys and other security parameters for SRTP, the MIKEY, Multimedia Internet KEYing, protocol can be used.

However as mentioned above, end-to-end security may not always be possible. If the end points belong to different operators, there are problems to set up the Security Association since inter-operator cross certification is currently not supported. It is also possible that the remote end point may not support the media protection protocol.

Various access technologies typically have their own protection mechanisms. For example, WLAN (the 802.11 series of specifications) has link layer encryption mechanisms. However, in situations such as public WLAN, these encryption mechanisms are usually not used.

The invention provides a method, system and network elements as defined in the claims.

The invention provides a method, system and network elements allowing an end point to inform the IMS network that the end point wants protection of the media stream over the access network. The invention provides mechanisms to set up Security Association between the end point and the Media Proxy (MP).

The invention provides mechanisms to allow a user to request the network to provide media protection for user plane data over the access network (e.g. between the user equipment, UE, and the Media Proxy, MP). The invention is also applicable for providing media protection when accessing the Multimedia Domain (MMD) in 3GPP2 networks.

The invention is able to extend the access connectivity e.g. of the IMS core from an homogeneous access, e.g. IPv6, Internet Protocol version 6, GPRS, General Packet Radio Service, access, to an heterogeneous generic IP access environment.

According to one aspect, the invention provides a system or method for providing media protection for media flow to and/or from an end point over an access network, wherein at least one of the end point and a network element are able to request media protection, and, when media protection is requested, the end point and an intermediate network element provide media protection for the media flow over the access network.

The intermediate network element may be a network element of a user plane such as a media proxy. The end point may be a user terminal such as a mobile user equipment.

Preferably, media traffic from the end point may be protected by applying encryption and/or integrity protection, and the intermediate network element preferably unprotects the media traffic before forwarding the media traffic. Preferably, the intermediate network element applies protection to media traffic targeted toward the end point. A multimedia network such as an Internet Multimedia Subsystem, IMS, or a Multimedia Domain, MMD, may be provided. Preferably, when media protection is requested, a security association is established between the first network element and the intermediate network element.

Preferably, the end point may send a message to the network element, the message including information requesting media protection, or including information acknowledging a requested media protection, and the network element and the end point establish a connection providing media protection for media flow between the end point and the intermediate network element. The network element may e.g. be an application layer gateway, ALG, or a Proxy Call State Control Function, P-CSCF.

The network element may e.g. push a security association, SA, to the intermediate network element, so as to enable media protection between the end point and the intermediate network element. The network element may for instance forward the message received from the end point to a remote network element after stripping the information requesting media protection from the message. The message can e.g. be a message of Session Initiation Protocol, SIP, and the information may e.g. be a Multimedia Internet Keying, MIKEY, message.

According to another aspect, the invention provides a user equipment for providing media protection for media flow to and from the user equipment, wherein the user equipment is configured to be able to request media protection, and the user equipment is configured to support establishing a connection providing media protection between the user equipment and an intermediate network element over an access network, when media protection is requested by the user equipment or a network element. Preferably, the user equipment is configured to send a message to a network element, the message including information requesting media protection, or including information acknowledging a media protection requested by the network element, the user equipment being configured to support establishing a connection providing media protection between the user equipment and the intermediate network element. Preferably, the user equipment is configured to decide on requesting media protection based on pre-configuration of the user equipment, and/or based on an input of a user of the user equipment, and/or based on network capabilities of a current access network.

According to another aspect, the invention provides a network element for assisting in providing media protection for media flow to and from an end point, wherein the network element is configured to send a message to, or receive a message from, the end point, the message including information requesting media protection, or including information acknowledging a requested media protection, the network element assisting in establishing the connection providing media protection between the end point and another network element. Preferably, the network element is configured to push a security association, SA, to the another network element, so as to enable media protection between the end point and the another network element. Preferably, the network element is configured to forward the message received from the end point to another network element after stripping the information requesting media protection from the message. The network element may e.g. be an Application layer gateway, ALG, or a Proxy Call State Control Function, P-CSCF.

According to another aspect, the invention provides a network element for handling media flow between an access network and a core network, the network element being adapted to receive a security association for the media flow, and to provide media protection for the media flow in accordance with the security association. The media protection may include protecting the media flow from the core network to the access network in accordance with the security association, and/or to unprotect the media flow from the access network to the core network in accordance with the security association. The network element may be a media proxy.

In the following, embodiments of the invention will be described with reference to the drawings.

### BRIEF DESCRIPTION OF THE DRAWINGS

FIG. 1 presents different access environments of the IMS,

FIG. 2 shows a typical scenario of a user equipment, UE, accessing IMS service through alternative accesses,

FIG. 3 shows a known IMS network architecture comprising an IMS Application Level Gateway, IMS-ALG,

FIG. 4 illustrates a typical scenario for establishing an end-to-end secure media session using SIP/MIKEY/SRTP,

FIGS. 5 and 6 illustrate message flow diagrams of a UE requesting media protection from an access network when the UE is a caller (FIG. 5), and when the UE is a callee (FIG. 6),

FIG. 7 presents procedures in which the established SA is pushed securely from IMS-ALG to a media proxy, MP,

FIG. 8 presents an embodiment implementation of the invention using extensions to SIP/MIKEY in a case when the UE is a caller requesting media protection over the access network,

FIG. 9 shows an embodiment of the invention using extensions to SIP/MIKEY when the UE is a caller but media protection over the access network is initiated by the IMS network,

FIG. 10 presents an embodiment of the invention by using extensions to SIP/MIKEY when the UE is a callee requesting media protection over the access network, and

FIG. 11 illustrates an implementation of the invention by using extensions to SIP/MIKEY when the UE is a callee but media protection over the access network is initiated by the IMS network.

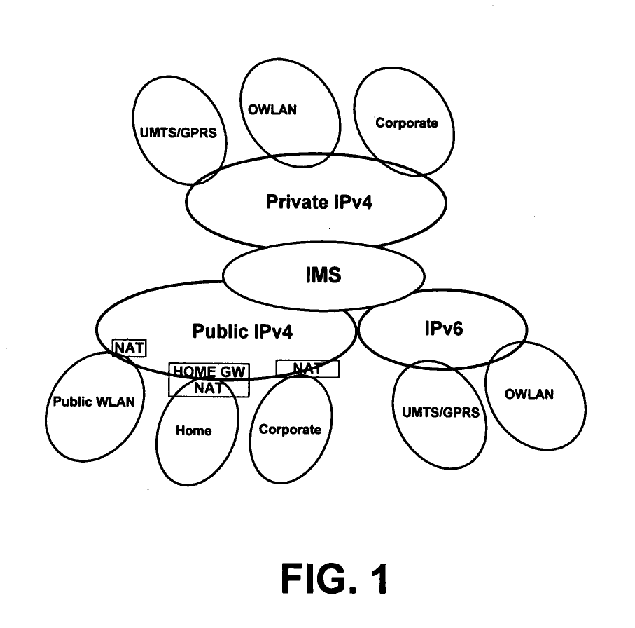

### DESCRIPTION OF EMBODIMENTS OF THE INVENTION

In embodiments of the invention, an end point is able to inform the IMS network that it wants protection of the media stream over the access network. The invention provides mechanisms to allow a user to request the network over the control plane to provide media protection for user plane data over the access network (e.g. between the user equipment, UE, and the Media Proxy, MP). The user plane data may be voice or content or other type of media.

According to embodiments of the invention, mechanisms are provided to set up Security Association between the end point and a Media Proxy (MP). Embodiments of the invention may include one or both of the following two components, namely a mechanism to allow an end point such as a mobile terminal of a user to inform the network, e.g. the IMS network, on desired media protection, or request the network for media protection, over the access network; and a mechanism to establish security association between an end point such as a mobile terminal and a network element such as the media proxy.

The mechanism to allow a mobile terminal to request the network for media protection over the access network may comprise the following functions and structures. The same mechanism can also be used to allow the IMS network to initiate such media protection. The request for media protection may be embedded e.g. in a control plane message such as a SIP signaling message being sent from a user equipment UE-1 towards a user equipment UE-2 through a control element of the control plane, e.g. P-CSCF of IMS. When UE-1 sends a SIP INVITE message, a “Media Protection Request” intended for the IMS network can be attached. The control element will interpret the request accordingly. The request should indicate the secure protocol that will be used to protect the media of the user plane, and may include information required for setting up the security association between the UE and the IMS network (more specifically between the UE and the Media Proxy). When a 200 OK is received, the control element can attach a “Media Protection Response” message into the 200 OK message. The control element may either grant or deny the media protection request.

The mechanism to establish security association between an end point such as a mobile terminal and a network element of the user plane such as the media proxy may for instance be implemented as follows. A mechanism is provided to establish security association between a mobile terminal and the media proxy. In 3GPP IMS, the UE and the network already have shared secrets that can be used to further derive a security association for media protection. Once the SA is established, the control element such as P-CSCF may securely push the SA to the media proxy. In cases where the control element is physically co-located or integrated with the MP, no additional security mechanism may be needed to push the SA from control element to MP. Finally, media traffic between UE-1 and MP can be protected using the security protocol selected and the SA established. Outgoing media traffic from UE-1 is protected by applying encryption and/or integrity protection. The MP will unprotect the data before forwarding the media streams. In a detailed implementation example MIKEY is used.

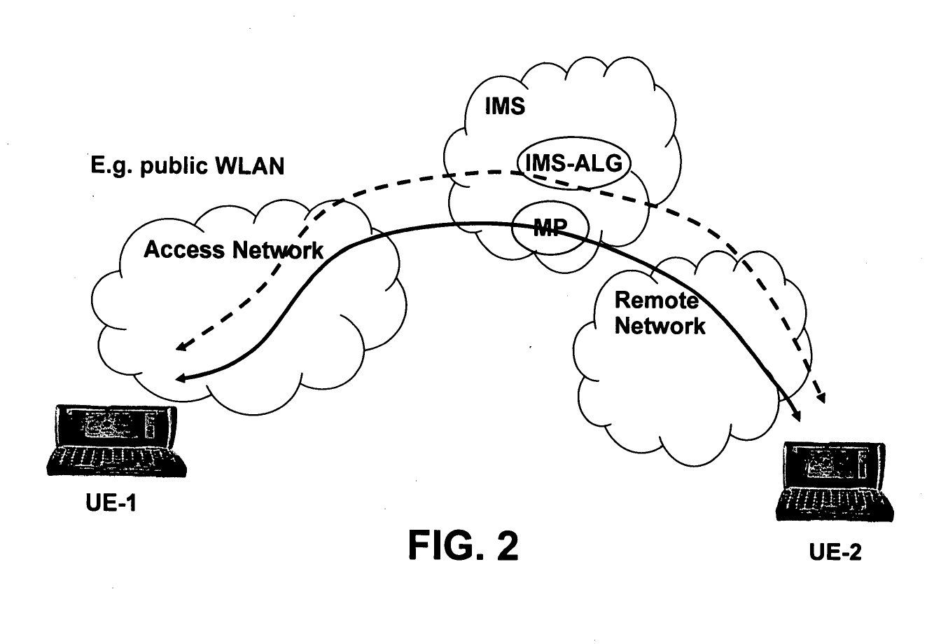

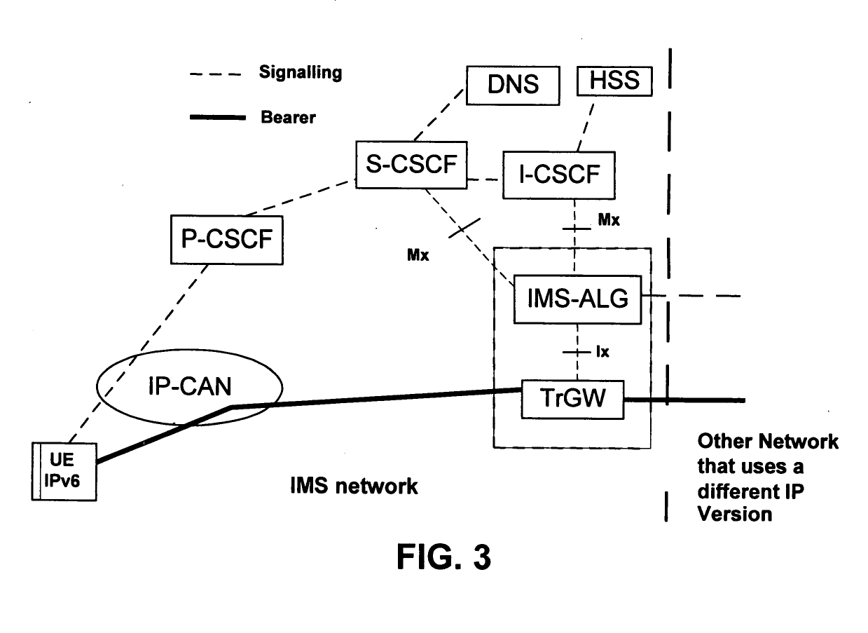

Referring to FIG. 2, a user using User Equipment UE-1 is e.g. trying to access the IMS through an access network, such as a public WLAN. The user wants to set up a multimedia communication session such as a VoIP call with another user who is using User Equipment UE-2. A SIP signaling message, shown as a broken line in FIG. 2, will be routed through a SIP Application Level Gateway (ALG) of the IMS, referred to as the IMS-ALG, and a remote network. The actual media traffic shown as a continuous line in FIG. 2 will go through a media proxy, MP. The IMS-ALG is a SIP ALG that can be located anywhere in the signaling path within the operator domain, see FIG. 3. The IMS ALG provides the necessary application function for SIP/SDP protocol stack in order to establish communication between IPv6 and IPv4 SIP applications. The IMS ALG may receive an incoming SIP message from CSCF nodes or from an external IPv4 SIP network. It then changes the appropriate SIP/SDP parameters, translating the IPv6 addresses to IPv4 addresses and vice versa. The IMS ALG may modify the SIP message bodies and headers that have IP address association indicated. The IMS ALG may request NA(P)T-PT to provide the bindings data between the different IP addresses (IPv6 to IPv4 and vice versa) upon session initiation, and will release the bindings at session release.

FIG. 3 shows a known structure illustrating the signaling and bearer paths in the IMS network. When a user A of UE initiates an IMS session towards a User B (not shown), via the session path for IMS, the session is analysed at the S-CSCF of UE. S-CSCF for user A determines via Domain Name System, DNS (or other mechanism) that the User B's domain cannot be communicated via IPv6 but can be via IPv4. S-CSCF then acquires the necessary resources (via IMS ALG and Translation Gateway TrGW) such as the IPv4 address and ports on behalf of user A so that User A can communicate with user B transparently. The S-CSCF/IMS-ALG continues IMS signalling towards User B network where User A's IPv6 address/port information is replaced by IPv4 information. When User (B) responds to the session initiation requests, the IMS-ALG will replace the IPv4 address/port information of User (B) with its own IPv6 information for signalling and with TrGW IPv6 information for the media path as the contact information of User (B) and forward the request to S-CSCF of UE (A). Session signalling path is then established between the UE and the S-CSCF, the S-CSCF and the IMS-ALG, the IMS-ALG and the external network for User B. The media path is established between the UE (A) and the TrGW, via the IP-CAN, and then between the TrGW and user B.

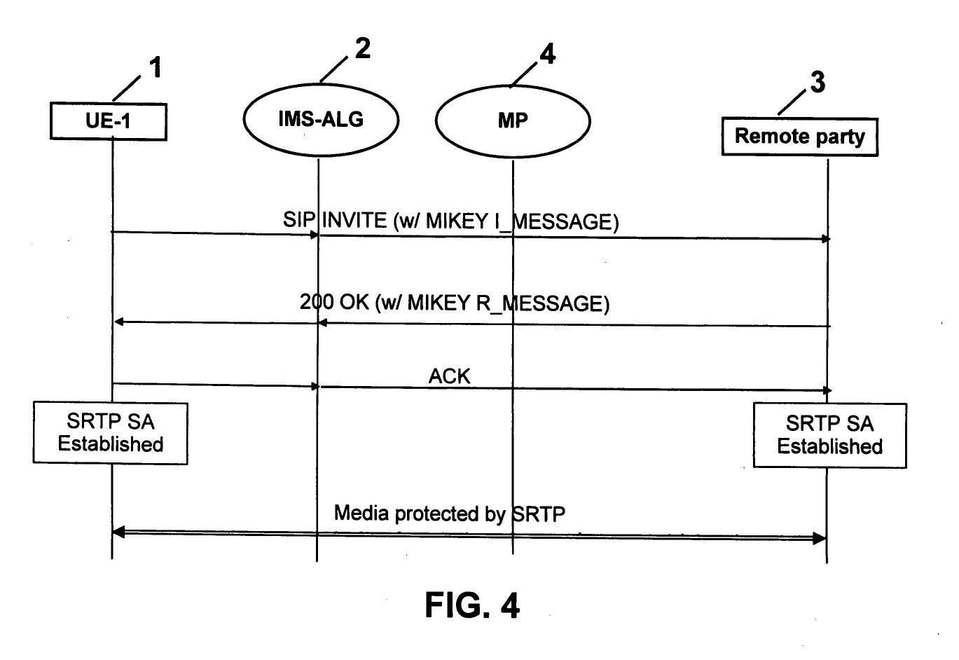

A method and system for establishing an end-to-end secure media session is by means of using SIP for signaling, SRTP for media protection, and MIKEY for key establishment. SRTP for media protection is one possible method but other methods may also be used. This is illustrated in FIG. 4.

In this case, UE-1 1 sends a message, e.g. SIP INVITE, to the remote endpoint 3 to initiate a session. A MIKEY Initiator Message (I_MESSAGE) is attached to the SDP, Session Description Protocol, payload of the message, e.g. SIP INVITE. Upon receiving this e.g. SIP message, the remote endpoint 3 responds with a SIP 200 OK to accept the call. Attached in the response is also a MIKEY Responder Message (R_MESSAGE). After exchanging the SIP handshake message, both parties are ready to establish the media session. At the same time, by exchange the MIKEY message, a security association (SA), comprising keys and other security related parameters (including the cryptographic algorithms to be used) is also established between the two parties “SRTP SA Established”. Media traffic (RTP) can then be protected using SRTP using the established SA. Similar mechanisms apply when UE-1 1 is a callee receiving a SIP call initiated by a remote party 3.

A possible implementation of the invention is based on modifications to the above scenario with extensions to the way MIKEY message is attached in the SDP payload of SIP messages, which is specified in J. Arkko, “Key Management Extensions for Session Description Protocol (SDP) and Real Time Streaming Protocol (RTSP”, IETF Work in progress, February 2005. An indication is needed such that a MIKEY message can be included and designated for an intermediate entity (e.g. IMS-ALG 2 in the present case).

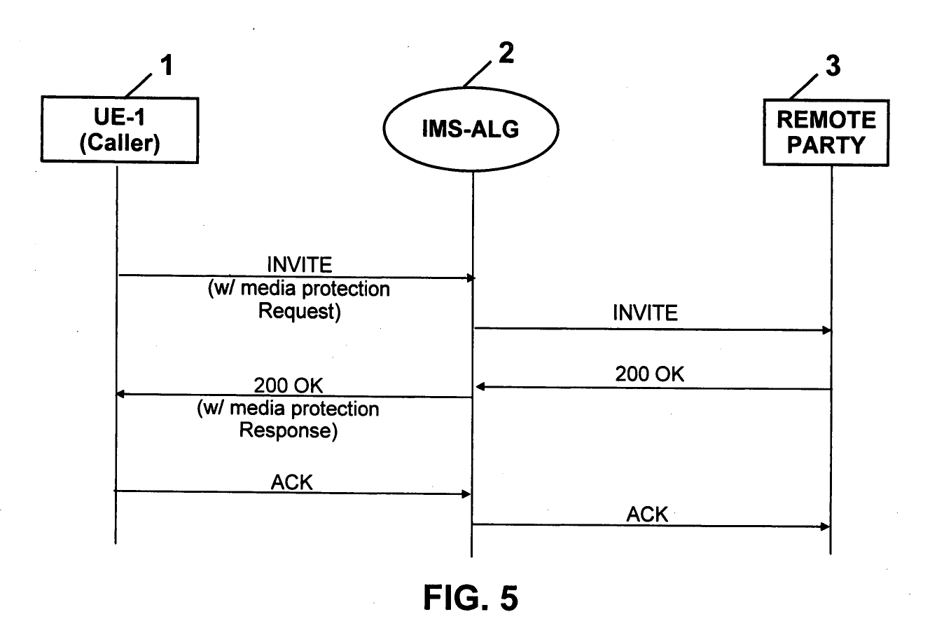

When the access network is not protected, and no end-to-end security mechanism is in place for protecting the media traffic (due to reasons mentioned above), UE-1 may request media protection over access network from the IMS. The UE-1 may decide to request media protection e.g. based on pre-configuration (by operator and/or user), and/or requested by the user on a case-by-case basis, and other information such as current network capabilities, for instance, if the UE is roaming in a WLAN where there is no link layer security provided, the UE may then decide that media protection over access network should be requested. The request for media protection may be embedded in the SIP signaling message being sent from UE-1 towards UE-2 through the IMS-ALG. This is illustrated in FIG. 5, where UE-1 acts as the caller.

In FIG. 5, when UE-1 sends a message such as a SIP INVITE message to the IMS network, a “Media Protection Request” can be attached to this message. This “Media Protection Request” is intended for the IMS network. The IMS network, preferably the IMS-ALG 2, will interpret the request accordingly. The IMS-ALG 2 is on the signaling path and understands this “Media Protection Request” and thus the mechanism specified in this invention. The “Media Protection Request” preferably but not necessarily indicates the secure protocol that will be used to protect the media, and may include information required for setting up the security association between the UE 1 and the IMS network (more specifically between the UE 1 and the Media Proxy). The IMS-ALG 2 will forward the INVITE to the remote party 3, preferably but not necessarily after stripping the “Media Protection Request”. When the IMS-ALG 2 receives a response message such as a 200 OK message of SIP from the remote party 3, the IMS-ALG 2 can attach a “Media Protection Response” message into the message returned to the UE 1 such as an 200 OK message. The IMS-ALG 2 may either grant or deny the media protection request.

Alternatively, it is possible that media protection is initiated by the IMS network. In this case, the “Media Protection Request” will be generated by the IMS network, for example by the IMS-ALG 2, and may be embedded in a message from the IMS-ALG 2 to the UE 1. As an example, the “Media Protection Request” may be embedded in the SIP 200 OK from IMS-ALG 2 to UE 1. The UE 1 is adapted to understand the “Media Protection Request” and provide media protection. The UE 1 will generate a “Media Protection Response” which may be embedded in a message from UE 1 to ALG 2, for example a SIP ACK message from UE 1. The “Media Protection Response” part may be stripped from the ACK message by the IMS-ALG 2 before forwarding the SIP ACK to the remote party 3.

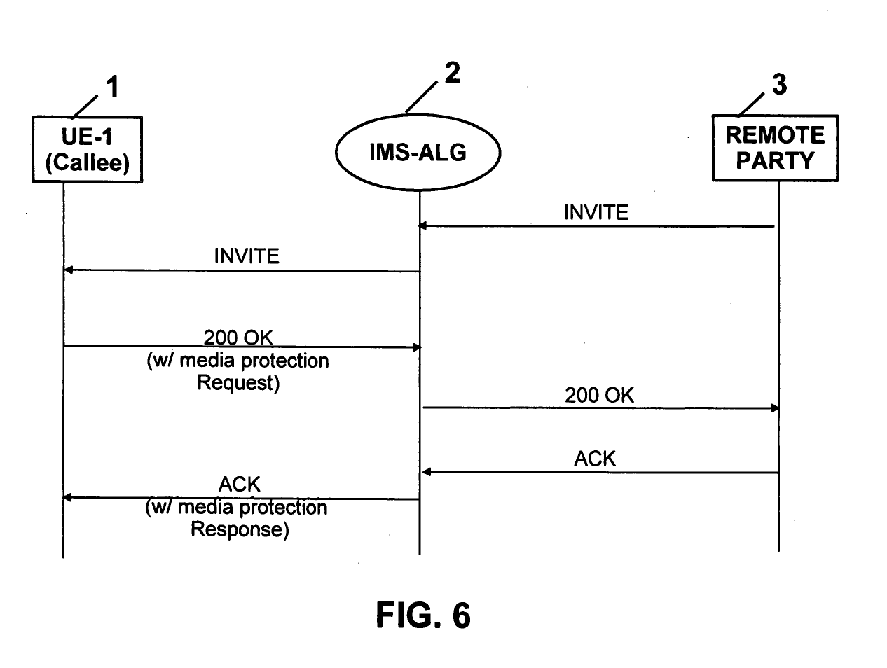

FIG. 6 further illustrates a scenario where UE-1 is the callee of a SIP call. The UE 1 is therefore the session terminating terminal instead of the originating terminal. A SIP INVITE is sent from the initiating remote party 3 through the IMS-ALG 2 to UE 1. In response, the UE 1 may request access network media protection by embedding a request such as e.g. the “Media Protection Request” message in a message sent from the UE 1 to the IMS-ALG 2, e.g. a 200 OK message. The 200 OK message is received by the IMS-ALG 2, which extracts (and may strip) the “Media Protection Request” before forwarding it to the caller 3. When an ACK is received from the caller 3, the IMS-ALG 2 then attaches its “Media Protection Response” message in the message, e.g. ACK, before forwarding it to UE 1.

Again, alternatively, it is possible for the IMS network to initiate the media protection. In this case, the “Media Protection Request” will be embedded in the message, e.g. SIP INVITE, forwarded by the IMS-ALG 2 to UE 1, and UE 1 will embed its “Media Protection Response” in its response, e.g. 200 OK message.

The mechanism to establish security association between a mobile terminal and the media proxy may comprise the following functions and structures.

For the purpose of media protection, a security association (SA), which includes at least one of crypto keys and various security parameters (including cryptographic algorithms) needed for the security protocol, is needed between the UE 1 or 3 and the IMS network (the Media Proxy 4 in particular). In 3GPP IMS, the UE 1 or 3 and the network already have shared secrets that can be used to further derive a security association for media protection.

Details of Security Association, SA, establishment are for example described in a book Gonzalo Camarillo et al., “The 3G IP Multimedia Subsystem”, John Wiley and Sons, 2004, pages 243 to 245. The features described there with regard to SA between P-CSCF and the terminal are also applicable to the present invention and can further be used for SA establishment between the terminal 1 and IMS-ALG 2.

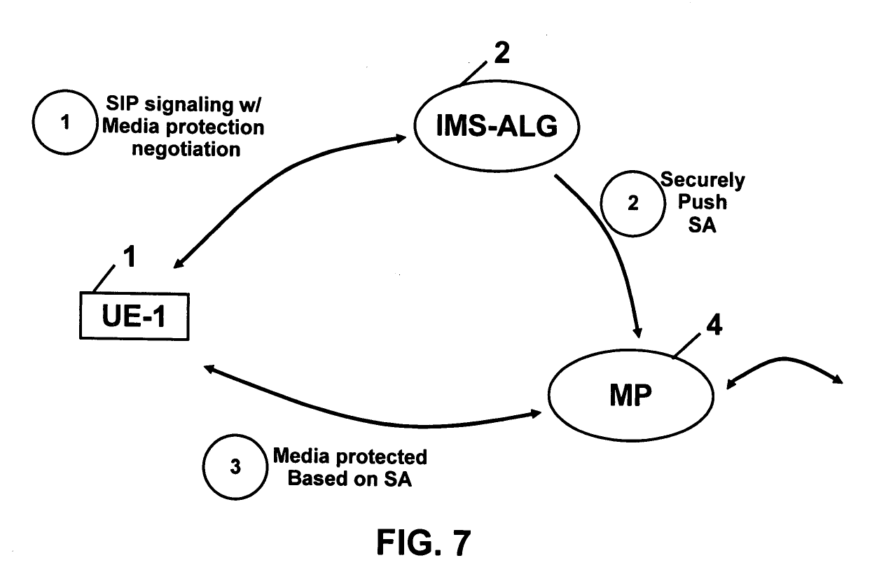

Referring to FIG. 7, when setting up a multimedia communication session, the UE-1 1 performs a SIP handshake with the remote party 3 (not shown in FIG. 7) through a control element of the control plane such as the IMS-ALG 2. Media protection is requested as described above in particular with reference to FIGS. 5 and 6. As a result, a security association will be established between UE-1 1 and the IMS-ALG 2. This is illustrated in Step 1 “SIP signaling w/Media protection negotiation” in FIG. 7.

Once the SA is established, the IMS-ALG 2 may securely push the SA to a network element of the user plane such as media proxy MP 4. In cases where the IMS-ALG 2 is physically collocated with the MP 4, no additional security mechanism may be needed to push the SA from IMS-ALG 2 to MP 4. This is illustrated in Step 2 “Securely Push SA” in FIG. 7. An appropriate mechanism may be used by the IMS-ALG 2 to securely push the SA to the MP 4. For example, in 3GPP, the interface between the IMS-ALG 2 and the MP 4 can be protected as specified in 3GPP TS 33.210 “Network Domain Security; IP network layer security” using the IPSec protocol. The IMS-ALG 2 and the MP 4 are typically owned by the same operator, and the security between them may be considered as network domain security. Any solution typically used for “network domain security” may be applied. Typical solutions include physical security (these entities are connected by a network privately owned by the operator, where no one else has access), or TLS/IPSec type solution. The MP4, when receiving the SA from the ALG 2, stores the SA and uses the SA to protect the media stream between the UE-1 1 and the MP 4.

Thus, media traffic between UE-1 1 and MP 4 can be protected using the security protocol selected and the SA established. This is illustrated in Step 3 “Media protected Based on SA” in FIG. 7. More specifically, outgoing media traffic from UE-1 1 is protected by applying encryption and/or integrity protection. The MP 4 will unprotect the data before forwarding the media streams. Other security mechanisms may be in place to protect the media streams from the MP 4 onward. In the reverse direction, the MP 4 will apply protection by applying encryption and/or integrity protection to incoming media traffic targeted toward the UE 1. The UE 1 will unprotect the media traffic received accordingly.

In this embodiment as well in the other embodiments of the invention, the MP 4 may be implemented as, or correspond to, a Multimedia Resource Function, MRF, which is described for instance in 3GPP TS 23.228 clause 4.7. The MRF is mainly target for media services associated with an AS (rather than a remote end-point), or multi-party conference calls. The present invention is also applicable even with multi-party conference calls, in which case the media flow goes through the MRF. Further, a MGW, Media Gateway, handles calls to the public switched telephone network, PSTN, so for calls from IMS to PSTN, the media gateway MGW may take the role of the MP 4.

The Media Proxy, MP, 4 may be arranged at the same functional location, and be similar to the translation gateway TrGW shown in FIG. 3.

Some of the functions of MP 4 include media transcoding, QoS assurance, NAPT traversal, and possibly charging record creation.

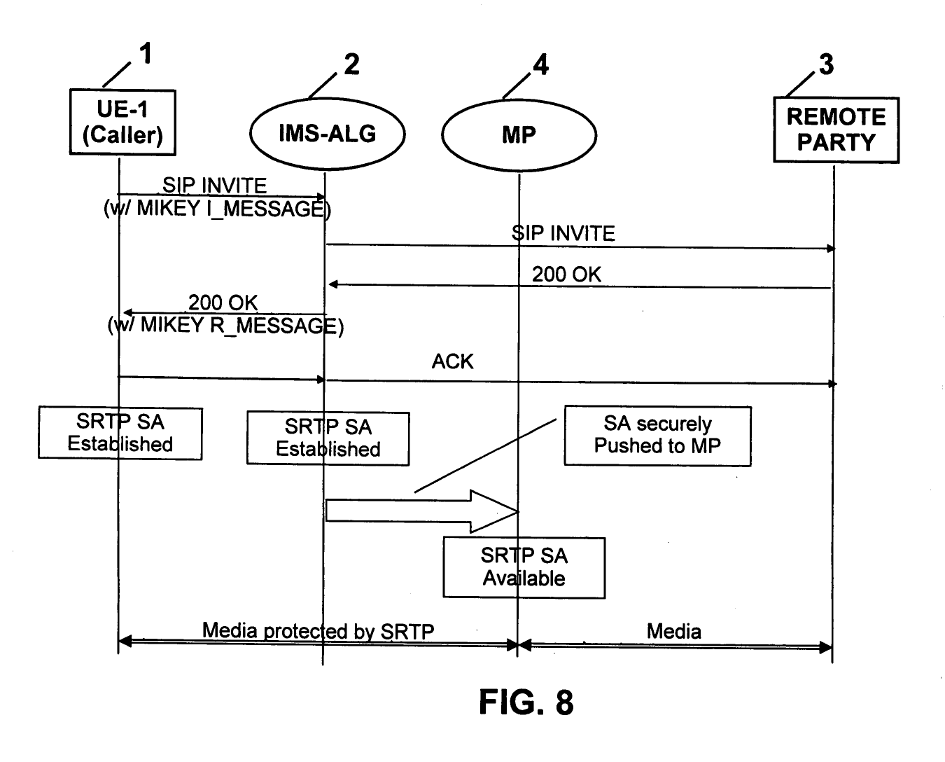

FIG. 8 illustrates a case where UE-1 1 acts as the caller. To request protection of media over the access network (between UE-1 1 and MP 4), UE-1 1 sends a SIP INVITE message to the remote party 3, with a MIKEY Initiator Message (I_MESSAGE) designated for the IMS network 3, not the remote party. This MIKEY I_MESSAGE represents the “Media Protection Request” described above with reference to FIGS. 4 to 7. The IMS-ALG 2 inspects the SDP payload of the SIP INVITE and extracts the I_MESSAGE designated for it. The IMS-ALG 2 may or may not strip the MIKEY I_MESSAGE before forwarding the SIP message as usual. Upon receiving the SIP INVITE, the remote party 3 responds with a 200 OK. Note that the remote party 3 may not be aware of the fact that UE-1 1 is requesting access network media protection since the MIKEY I_MESSAGE may be stripped by the IMS-ALG 2 (or even if not, the MIKEY I_MESSAGE is not designated to the remote party 3). The IMS-ALG 2, upon receiving the 200 OK message, inserts its own MIKEY R_MESSAGE. This MIKEY R_MESSAGE represents the “Media Protection Response” message described above with reference to FIGS. 4 to 7. After the 200 OK message is received by UE-1 1, the MIKEY handshake is completed between UE-1 1 and IMS-ALG 2. The SRTP SA is established between UE-1 1 and IMS-ALG 2.

The IMS-ALG 2 then pushes the SRTP SA securely to the MP 4. At this point, UE-1 1 can send media traffic protected using SRTP to the MP 4. The MP 4 will unprotect the media before forwarding it downstream. In the reverse direction, the MP 4 will apply SRTP protection to the media before sending it over the access network to UE-1 1.

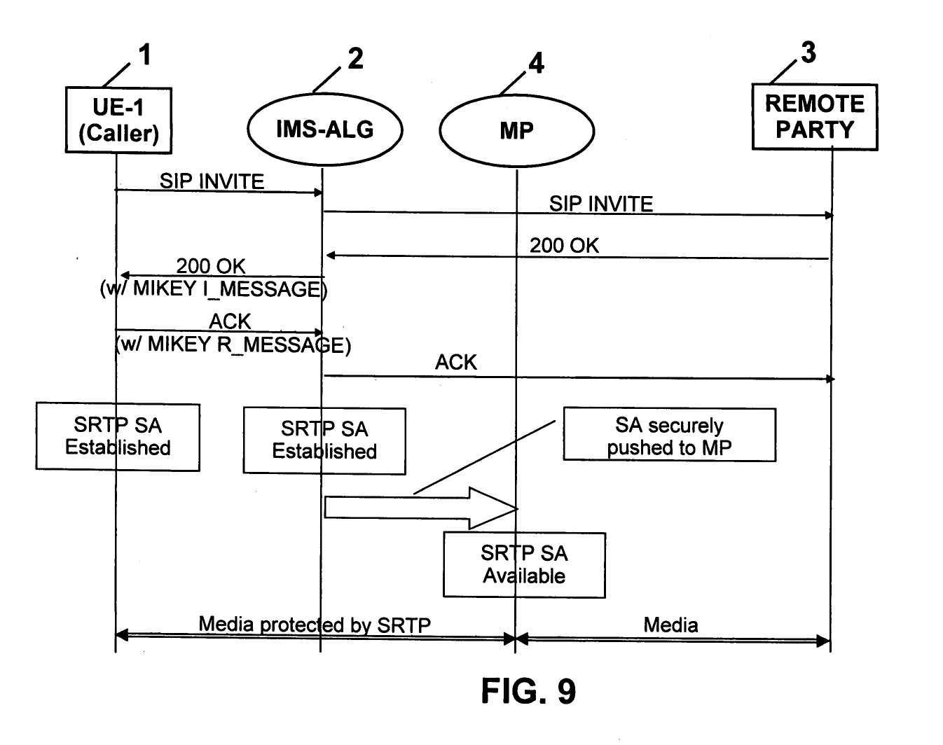

FIG. 9 illustrates a case where UE-1 1 is a caller but the media protection is actually initiated by the IMS network. In this case, the MIKEY I_MESSAGE is included in a message, e.g. the 200 OK message, forwarded by the IMS-ALG 2. UE-1 1 attaches the MIKEY R_MESSAGE in the ACK message.

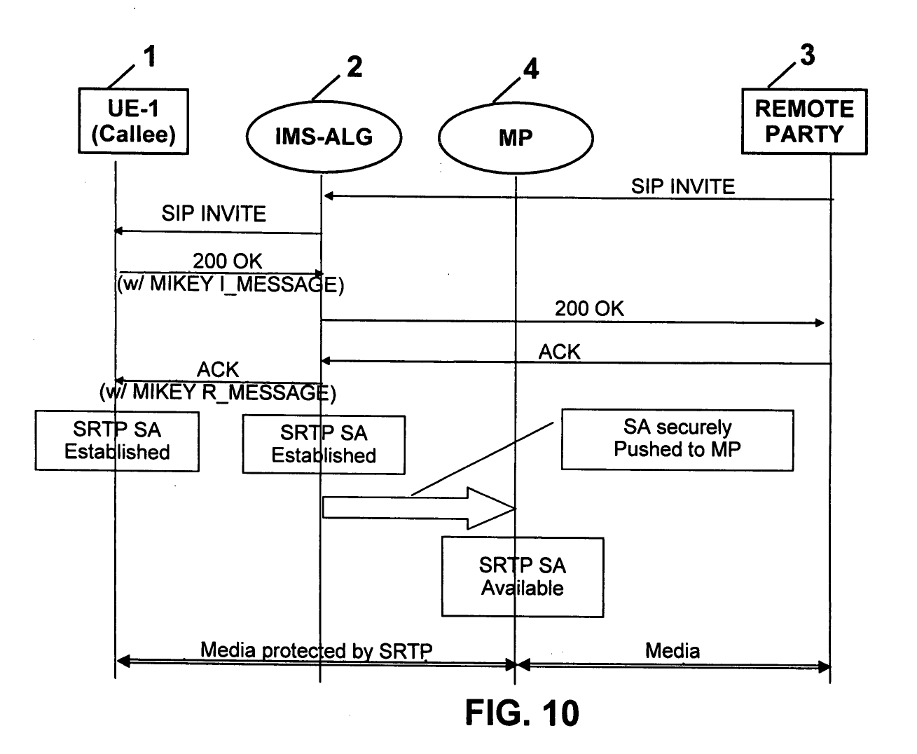

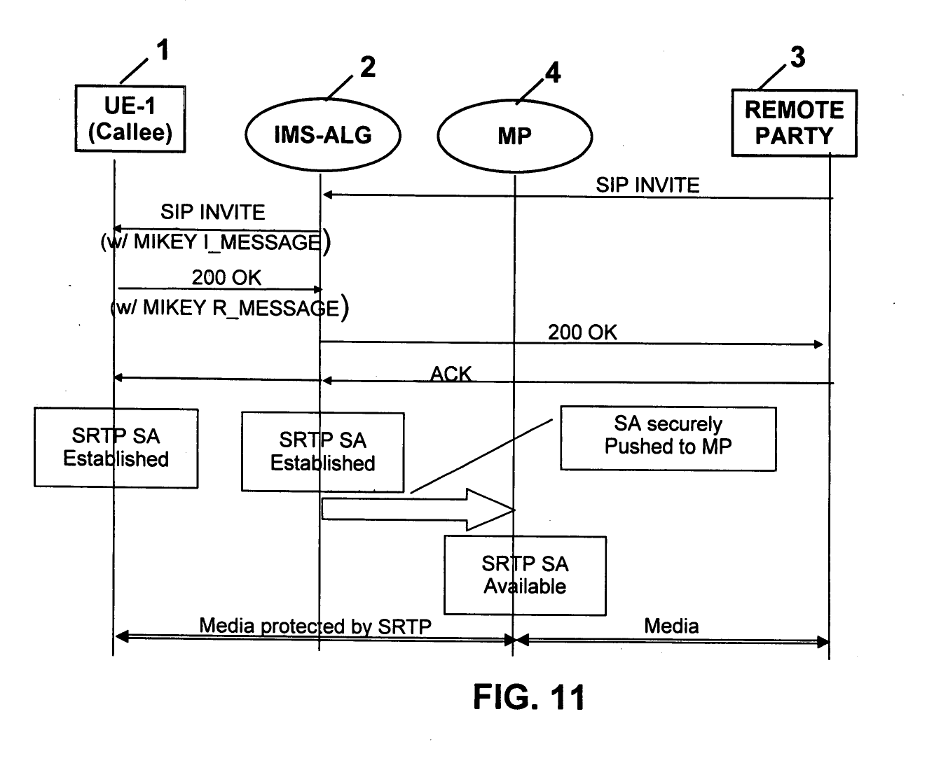

FIGS. 10 and 11 illustrate a situation where UE-1 1 acts as a callee, that is a terminating party, to a VOIP call. As shown in FIGS. 10, 11, a message, e.g. SIP INVITE, is sent to UE-1 1 through the IMS-ALG 2 by a remote party 3. Upon receiving the SIP INVITE, UE-1 1 may request media protection over the access network by attaching e.g. a MIKEY I_MESSAGE in the 200 OK response. This MIKEY I_MESSAGE is designated to the IMS network (IMS-ALG 2 in particular). The IMS-ALG 2 will extract (and may strip) the MIKEY I_MESSAGE before forwarding it onward to the remote party 3. When a message, e.g. the final ACK generated by the remote party 3 is received by IMS-ALG 2, the IMS-ALG 2 will attach its own MIKEY R_MESSAGE, before forwarding it to UE-1 1. At this point, the SRTP SA has been established between UE-1 1 and the IMS-ALG 2. Once the SA is securely pushed to the MP 4, secure media communication can be applied between UE-1 1 and MP 4.

FIG. 11 illustrates a situation where UE-1 1 is a callee and access network media protection is initiated by the IMS network. This case is handled in a similar manner as the above case of FIG. 10. In this case, the MIKEY I_MESSAGE is attached to the SIP INVITE message sent from the remote party 3 to the IMS-ALG 2 before the IMS-ALG 2 forwards it to UE-1 1. In response to this, UE-1 1 attaches its MIKEY R_MESSAGE in the 200 OK response, which is then extracted (or may be stripped) by the IMS-ALG 2 before forwarding the 200 OK message to the remote party 3. The SRTP SA is then established between UE-1 1 and the IMS-ALG 2, and is pushed by the IMS-ALG 2 to the MP 4. As a result, media protection between UE-1 1 and MP 4 is established.

MIKEY specifies three methods for key transport/agreement, namely Pre-shared secret, Public-Key cryptography, and Diffie-Hellman. The invention can use any of these mechanisms. For example, as UE-1 1 and the network already have shared secrets, the pre-shared secret key transport mechanism can be used in MIKEY between UE-1 1 and IMS-ALG 2.

In addition to key establishment, MIKEY at the same time allows the two parties to agree on the specific security policy for use by the data security protocol (SRTP in the above embodiments as an example) under negotiation. Currently, only SRTP policy is defined in MIKEY, which includes the specification of encryption algorithm, authentication algorithm, SRTP Pseudo Random Function, key lengths, etc. Capability discovery in MIKEY is by means of the Initiator sending out the security policy to be used. If the Responder does not support it, it may send an error message together with its own capabilities. The Initiator then has to send a new MIKEY message if a common security policy can be agreed on.

It should be noted that although IMS-ALG 2 has been used in the above description of embodiments of the invention, in practice, any entity in the operator (IMS) domain may perform the operations, in particular such an entity that is on the signaling path, understands the extension as specified in the invention, and is capable of communicating with the MP 4. For example, a software module co-located with the P-CSCF, Proxy Call State Control Function, may be used.

It should also be noted that although one-to-one VoIP call has been used in the above description of embodiments of the invention, the invention is also applicable to multiparty conference calls, as well as other multimedia sessions.

The invention provides, among others, the above and following improvements. The invention provides a means for the media stream to be protected over the access network (especially when the access network is unprotected). The invention does not require new security keys to be shared by the nodes but can re-use existing ones to derive the session keys. The invention is flexible allowing several schemes to be used to set up the SA between the UE and the MP (IKE, MIKEY, Public Key technology). The invention does not require inter-operator cross certification. The invention works whether the UE is a caller or a callee.

The invention provides extensions to existing protocols (SIP, MIKEY). The UE and the IMS-ALG are able to support the extensions. The MP is able to support encryption/integrity protection algorithms. The invention allows media stream to be protected over the access network thus preventing eavesdropping, traffic injection, and other attacks.

According to embodiments of the invention, a MIKEY like negotiation is re-used in IMS system to negotiate media protection between UE and network and relaying the SA information from an IMS control element such as e.g IMS-ALG or P-CSCF, to MP. Media protection may also be provided for terminating case. As an alternative TLS might be used for media protection. End-to-middle media protection is provided for e.g. the caller-party side, or for the called party, too. Due to decoupling of the solution from P-CSCF the solution can be implemented even without changes in 3GPP IMS architecture.

The invention can also be implemented in software form. The invention thus further provides a computer program product which includes a program comprising software code portions for performing one, some or all of the steps or functions mentioned above or in any one of the claims when the program is run on. The program may be run on an appropriate device such as a program processing device, e.g. a computer or ASIC etc. The processing device may be part of, or correspond to, the computer or may be part of one or more of the network elements or user equipments. The computer program product may comprise a computer-readable medium on which the software code portions are stored. The program may be directly loadable into an internal memory of the processing device, e.g. via a program data carrier such as CD-ROM, or online, e.g. via Internet, LAN etc. In an embodiment, the invention provides a computer program product including a program for a user equipment, comprising software code portions for performing, when the program is run on the user equipment, the steps of: requesting media protection, and supporting establishing a connection providing media protection between the user equipment and an intermediate network element over an access network, when media protection is requested by the user equipment or a network element.

In another embodiment, the invention provides a computer program product including a program for a network element as defined above or in any one of the claims. The program may comprise software code portions for performing, when the program is run on the network element, the steps of: sending a message to, or receiving a message from, the end point, the message including information requesting media protection, or including information acknowledging a requested media protection, and assisting in establishing the connection providing media protection between the end point and another network element; or receiving a security association for the media flow, and providing media protection for the media flow in accordance with the security association.

The invention is not limited to the above description of embodiment details, and also covers any modifications, additions, or omissions of the above described features.

1. A method for providing media protection for media flow to and/or from an end point over an access network, the method comprising:
requesting from at least one of the end point and a network element media protection; and
providing, when media protection is requested, media protection for the media flow over the access network, wherein the media protection is provided by the end point and an intermediate network element.

2. The method according to claim 1, wherein the intermediate network element is a network element of a user plane.

3. The method according to claim 2, wherein the network element of the user plane is a media proxy.

4. The method according to claim 1, wherein the end point is a user terminal.

5. The method according to claim 1, wherein media traffic from the end point is protected by applying encryption and/or integrity protection, and the intermediate network element unprotects the media traffic before forwarding the media traffic.

6. The method according to claim 1 , wherein the intermediate network element applies protection to media traffic targeted toward the end point.

7. The method according to claim 1, wherein a multimedia network is provided, and the multimedia network is one of an Internet Multimedia Subsystem (IMS), and a Multimedia Domain (MMD).

8. The method according to claim 1, wherein, when media protection is requested, a security association is established between the first network element and the intermediate network element.

9. The method according to claim 1, comprising the steps:
sending, by the end point, a message to the network element, the message includes information requesting media protection or information acknowledging a requested media protection; and
establishing, by the network element and the end point, a connection providing media protection for media flow between the end point and the intermediate network element.

10. The method according to claim 1, wherein the network element is an application layer gateway (ALG), or a Proxy Call State Control Function (P-CSCF).

11. The method according to claim 9, wherein the network element pushes a security association (SA), to the intermediate network element, so as to enable media protection between the end point and the intermediate network element.

12. The method according to claim 9, wherein the network element forwards the message received from the end point to a remote network element after stripping the information requesting media protection from the message.

13. The method according to claim 9, wherein the message is a message of Session Initiation Protocol (SIP) and the information is a Multimedia Internet Keying, (MIKEY), message.

14. A system for providing media protection for media flow to and/or from an end point via an access network, the system comprising:
at least one of the end point and a network element, wherein the at least one of the end point and the network element are configured to request media protection,
wherein the system is configured to establish a connection providing media protection between the end point and an intermediate network element over the access network, when media protection is requested.

15. A user equipment for providing media protection for media flow to and from the user equipment the user equipment comprising:
a requesting module to request media protection; and
a connection module , wherein the connection module is configured to support establishing a connection providing media protection between the user equipment and an intermediate network element over an access network, when media protection is requested by the user equipment or a network element.

16. The user equipment according to claim 15, wherein the user equipment is configured to send a message to a network element, the message includes information requesting media protection or information acknowledging a media protection requested by the network element, and wherein the user equipment is configured to support establishing a connection providing media protection between the user equipment and the intermediate network element.

17. The user equipment according to claim 15, wherein the message is a message of Session Initiation Protocol (SIP), and the information is a Multimedia Internet Keying (MIKEY) message.

18. The user equipment according to claim 15, wherein the user equipment is configured to decide on requesting media protection based on at least one of a pre-configuration of the user equipment, and based on at least one of an input of a user of the user equipment, and network capabilities of a current access network.

19. A network element for assisting in providing media protection for media flow to and from an end point the network element comprising a transmitter/receiver means, wherein the transmitter/receiver means is configured to send a message to, or receive a message from, the end point, the message including information requesting media protection, or including information acknowledging a requested media protection, and wherein the network element assists in establishing the connection providing media protection between the end point and a second network element.

20. The network element according to claim 19, wherein the network element is configured to push a security association (SA) to the another network element, so as to enable media protection between the end point and the a second network element.

21. The network element according to claim 19, wherein the network element is configured to forward the message received from the end point to a second network element after stripping the information requesting media protection from the message.

22. The network element according to claim 19, wherein the network element is an Application layer gateway (ALG), or a Proxy Call State Control Function (P-CSCF).

23. A network element for handling media flow between an access network and a core network,
the network element being configured to receive a security association for the media flow, and to provide media protection for the media flow in accordance with the security association.

24. The network element according to claim 23, wherein the media protection includes protecting the media flow from the core network to the access network in accordance with the security association, and/or to unprotect the media flow from the access network to the core network in accordance with the security association.

25. Network element according to claim 23, wherein the network element is a media proxy (MP), a multimedia resource function (MRF), or a media gateway (MGW).

26. A computer program embodied on computer readable medium for a processing device, comprising software code portions for performing the steps of claim 1 when the program is run on the processing device.

27. The computer program according to claim 26, wherein the program is directly loadable into an internal memory of the processing device.

28. A computer program embodied on computer readable medium for a user equipment as defined in claim 15, comprising software code portions for performing, when the program is run on the user equipment, the steps of:
requesting media protection; and
supporting the establishment of a connection providing media protection between the user equipment and an intermediate network element over an access network when media protection is requested by the user equipment or a network element.

29. A computer program for a network element as defined in claim 19, comprising software code portions for performing, when the program is run on the network element, at least one of the steps of:
sending a message to, or receiving a message from, the end point, the message including information requesting media protection, or including information acknowledging a requested media protection, and assisting in establishing the connection providing media protection between the end point and another network element, or
receiving a security association for the media flow, and providing media protection for the media flow in accordance with the security association.
